(19) United States
(12) Patent Application Publication
(10) Pub. No.: US 2010/0199320 A1
(43) Pub. Date: Aug. 5, 2010

(54) MULTIMODAL ESCALATION TO ENDPOINTS IN ENHANCED COMMUNICATION SYSTEMS

(75) Inventors: Rajesh Ramanathan, Redmond, WA (US); Pradipta Kumar Basu, Redmond, WA (US); Ankit Tandon, Bellevue, WA (US); Stephen Houchen, Redmond, WA (US); Stephane Taine, Redmond, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/364,050

(22) Filed: Feb. 2, 2009

(51) Int. Cl. H04N 7/173; H04L 12/56

(52) U.S. Cl. 725/109; 370/352

(57) ABSTRACT

Subscribers and endpoints of enhanced multimodal communication systems are enabled to direct call requests and escalations during an existing conversation based on capabilities of endpoints. A list of communication mode/endpoint identifiers are exchanged when a conversation is established, enabling the endpoints to direct requests to for particular communication modes to endpoints capable of facilitating the communication mode at any point during the conversation. Additional capabilities/endpoints are added to the list through updates during the conversation.

### BACKGROUND

Modern communication systems have a large number of capabilities including integration of various communication modalities with different services. For example, instant messaging, voice/video communications, data/application sharing, white-boarding, and other forms of communication may be combined with presence and availability information of subscribers. Such systems may provide subscribers with the enhanced capabilities such as providing instructions to callers for various status categories, alternate contacts, calendar information, and comparable features.

A number of such modern communications are multi-modal, meaning multiple modes of communication such as voice, data, video, and comparable ones may be employed in a single communication session to complement each other. Moreover, some unified communication applications enable a user to log in from multiple endpoints or devices. For example, a user may log in to a mobile device and a desktop phone using a mobile version and a phone version of the communication application, respectively. Hence, when a caller sends a request for communication to the user, the user may potentially accept the request from any of the different devices or endpoints. However, devices may have varying capabilities regarding communication modalities. For example, the phone version of the communication application may not be able to handle instant messaging, while the mobile version of the communication application may not be able to handle video communications.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to enabling subscribers of enhanced multimodal communication systems to direct call requests and escalations during an existing conversation based on capabilities of participating. According to some embodiments, a list of identifiers associated with different modes of communication and endpoint may be exchanged when a conversation is established, enabling client applications to direct requests for particular communication modes to endpoints capable of facilitating the communication mode at any point during the conversation. Additional capabilities/endpoints may also be advertised through updates during the conversation.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 is a diagram illustrating an example unified communications system, where embodiments may be implemented for multimodal escalation to endpoints;

FIG. 2 is a conceptual diagram illustrating a basic example system for multimodal escalation during a communication session;

FIG. 3 is an action diagram illustrating interactions between different components of a communication system according to embodiments;

FIG. 4 is a networked environment, where a system according to embodiments may be implemented;

FIG. 5 is a block diagram of an example computing operating environment, where embodiments may be implemented; and

FIG. 6 illustrates a logic flow diagram for managing multimodal escalations during an existing communication session in a communication system according to embodiments.

### DETAILED DESCRIPTION

As briefly described above, communication modes may be escalated during conversation sessions by employing communication mode/endpoint identifiers exchanged at the beginning of a session and updated as necessary during the session. In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While the embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium can for example be implemented via one or more of a volatile computer memory, a non-volatile memory, a hard drive, a flash drive, a floppy disk, or a compact disk, and comparable media. The computer program product may also be a propagated signal on a carrier (e.g. a frequency or phase modulated signal) or medium readable by a computing system and encoding a computer program of instructions for executing a computer process.

Throughout this specification, the term “platform” may be a combination of software and hardware components for managing multimodal communications. Examples of platforms include, but are not limited to, a hosted service executed over a plurality of servers, an application executed on a single server, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example operations is provided below.

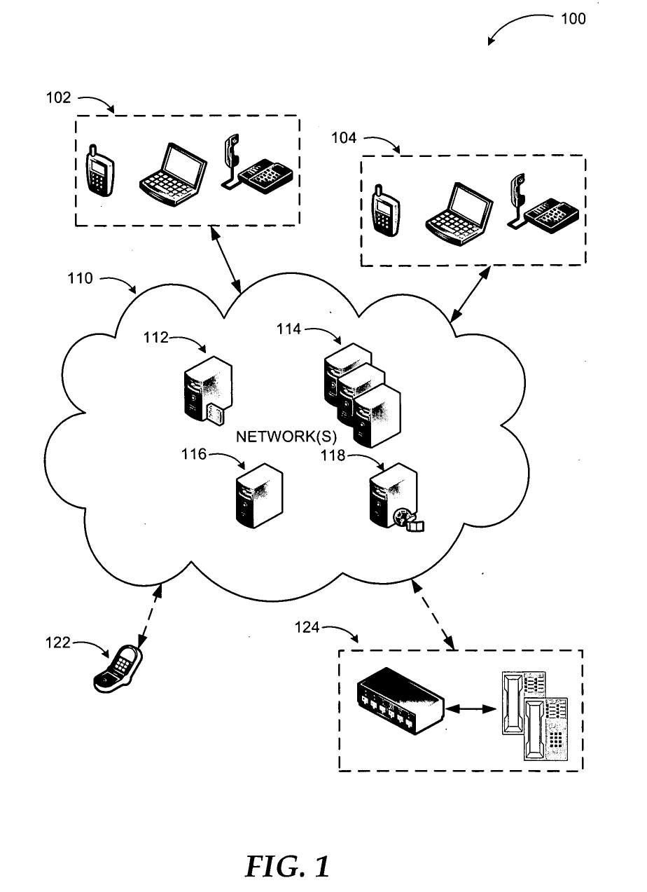

Referring to FIG. 1, diagram 100 of an example unified communications system, where embodiments may be practiced, is illustrated. A unified communication system is an example of modern communication systems with a wide range of capabilities and services that can be provided to subscribers. A unified communication system is a real-time communications system facilitating instant messaging, presence, audio-video conferencing, web conferencing functionality, and comparable capabilities.

In a unified communication (“UC”) system such as the one shown in diagram 100, users may communicate via a variety of end devices (102, 104), which are client devices of the UC system. Each client device may be capable of executing one or more communication applications for voice communication, video communication, instant messaging, application sharing, data sharing, and the like. In addition to their advanced functionality, the end devices may also facilitate traditional phone calls through an external connection such as through PBX 124 to a Public Switched Telephone Network (“PSTN”). End devices may include any type of smart phone, cellular phone, any computing device executing a communication application, a smart automobile console, and advanced phone devices with additional functionality.

UC Network(s) 110 includes a number of servers performing different tasks. For example, UC servers 114 provide registration, presence, and routing functionalities. Routing functionality enables the system to route calls to a user to anyone of the client devices assigned to the user based on default and/or user set policies. For example, if the user is not available through a regular phone, the call may be forwarded to the user's cellular phone, and if that is not answering a number of voicemail options may be utilized. Since the end devices can handle additional communication modes, UC servers 114 may provide access to these additional communication modes (e.g. instant messaging, video communication, etc.) through access server 112. Access server 112 resides in a perimeter network and enables connectivity through UC network(s) 110 with other users in one of the additional communication modes. UC servers 114 may include servers that perform combinations of the above described functionalities or specialized servers that only provide a particular functionality. For example, home servers providing presence functionality, routing servers providing routing functionality, rights management servers, and so on. Similarly, access server 112 may provide multiple functionalities such as firewall protection and connectivity, or only specific functionalities.

Audio/Video (A/V) conferencing server 118 provides audio and/or video conferencing capabilities by facilitating those over an internal or external network. Mediation server 116 mediates signaling and media to and from other types of networks such as a PSTN or a cellular network (e.g. calls through PBX 124 or from cellular phone 122). Mediation server 116 may also act as a Session Initiation Protocol (SIP) user agent.

In a UC system, users may have one or more identities, which is not necessarily limited to a phone number. The identity may take any form depending on the integrated networks, such as a telephone number, a Session Initiation Protocol (SIP) Uniform Resource Identifier (URI), or any other identifier. While any protocol may be used in a UC system, SIP is a preferred method.

SIP is an application-layer control (signaling) protocol for creating, modifying, and terminating sessions with one or more participants. It can be used to create two-party, multiparty, or multicast sessions that include Internet telephone calls, multimedia distribution, and multimedia conferences. SIP is designed to be independent of the underlying transport layer.

SIP clients may use Transport Control Protocol (“TCP”) to connect to SIP servers and other SIP endpoints. SIP is primarily used in setting up and tearing down voice or video calls. However, it can be used in any application where session initiation is a requirement. These include event subscription and notification, terminal mobility, and so on. Voice and/or video communications are typically done over separate session protocols, typically Real-time Transport Protocol (“RTP”).

In a system according to embodiments, client applications may include a complete list of communication mode/endpoint identifiers such as Globally Routable User Agent Uniform Resource Identifiers (GRUUs) for each different mode of communication in the messages exchanged while establishing the existing mode of communication. In the SIP infrastructure, this may be accomplished by putting the GRUU list in the INVITE and OK/ACK exchanged between the client applications for the first mode of communication. While sending the INVITE for a new mode during the same conversation, the calling client may send the INVITE to the GRUU specified for that mode of communication in the list obtained from the remote party. A conversation identifier may be employed by the clients to determine different modes belonging to the same conversation.

While the example system in FIG. 1 has been described with specific components such as mediation server, A/V server, and similar devices, embodiments are not limited to this system of the example components and configurations. A service for managing multimodal communications with escalation during a same conversation may be implemented in other systems and configurations employing fewer or additional components.

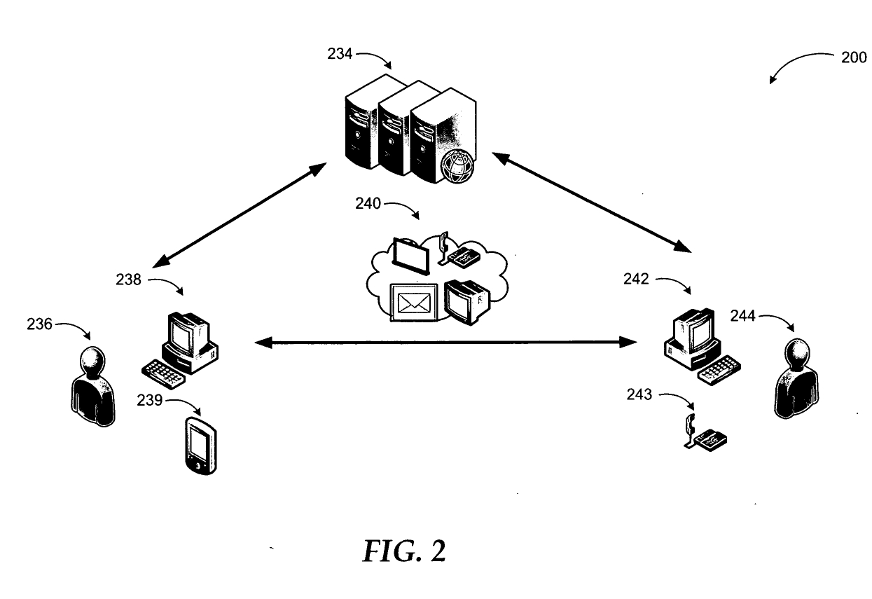

FIG. 2 is a conceptual diagram 200 illustrating a basic example system for multimodal escalation during a communication session. While a system according to embodiments is likely to include a number of servers, client devices, and services such as those illustratively discussed in FIG. 1, only those relevant to embodiments are shown in FIG. 2.

As mentioned previously, communication between two or more users in an enhanced communication system such as a UC system may be facilitated through multiple devices with varying communication mode capabilities. In a UC system employing SIP for communication between endpoints, a caller initiates a communication session by sending an INVITE to the called party. The called party may potentially accept the INVITE from a number of different devices or endpoints. However, not all these devices can handle all forms or modalities of communication. In a system according to embodiments, the INVITE is sent to devices capable of handling the requested mode of communication.

According to an example scenario, a communication server (e.g. server 234) may facilitate a conversation between a client application providing communication UIs to a user and an automated application (e.g. a bot). The conversation may start in audio mode (e.g. a user talking to an automated service center). Later in the conversation, the bot may request the user to provide a form and send the form as file transfer to the client application of the user. The client application may send the file back, which may be facilitated by another server responsible for file transfers and processing.

The basic components of a system according to embodiments include client devices 238 and 239 executing communication applications for user 236, client devices 242 and 243 executing different versions of the same or a different communication application for user 244, and servers 234. The communication applications for users 236 and 244 facilitate multi-modal communication sessions 240 (over one or more networks) between the users 236 and 244, as well as the users and automated applications (bots) on one or more of the servers 234.

As a follow-on to the above discussed example scenario, one or both of the users 236 and 244 may initiate a voice call with a bot executed on one of the servers 234 through their client applications exchanging INVITE and OK messages with the bot that include a predefined header for each modality containing the GRUU of the remote user that supports the modality (in a SIP based communication system). At any point during the conversation the bot or one of the client applications may escalate the modality as discussed in more detail below. Each modality within the conversation may be managed by a different server such as a file server for file exchanges, an A/V server for managing audio/video communications, an email server for managing exchange of emails or instant messages, and so on.

According to another example scenario, automated services for bots may switch over between servers to enable maintenance. In that case, each service is able to maintain the tie to an appropriate alternate service such that client applications migrate to the new service instance when adding new modes. A conversation id may be utilized by the client applications and bots to keep track of the conversation as new modes are added or existing modes removed. According to further embodiments, automated client applications may escalate conversation modalities as well. For example, a client application detecting a user adding another device (e.g. while using a desktop computer, the user may activate a connected phone device or activate video conference capabilities) may automatically initiate the escalation of modalities within the system.

Other modalities that may be used video conferencing, white-boarding, file transfer, and comparable ones. During the conversation—i.e. after the exchange of GRUU list has been performed—if a client application/bot needs to update its list due to the addition of a new endpoint or a change in the software capabilities, it may send an UPDATE request with the new list using the predefined header. The remote party may then update its stored list with the new list.

The updates to the list of endpoints/communication modes may be based on a change in the capability of participating client devices (and communication applications), joining of an additional user, changes in user rights, or other conditions. Other conditions may include network based conditions such as usage, available bandwidth, time of day, location of user(s), and so on (some communication modes may be available only based on one or more of these conditions). Similarly, client device capabilities may change based on an upgrade of communication application, addition or removal of a peripheral (e.g. a microphone, speaker, etc.). The update of the list may be performed if an endpoint goes down or if a more preferred endpoint for a particular communication mode comes up.

By enabling escalation of modalities during a conversation, a nature of the conversation is also preserved. As discussed previously, preferences and call handling rules for incoming calls may not be applied to escalated modalities. Similarly, conversation rights may be applied to all communication modes invoked during the same conversation and associated data (e.g. recordings of voice/video communication, attachments of emails, and similar aspects).

According to one embodiment, a history of involved endpoints with a conversation and their capabilities may be stored as part of the conversation history such that the same conversation may be restarted involving the same endpoints or a new conversation with the same endpoints may be started based on the modalities employed.

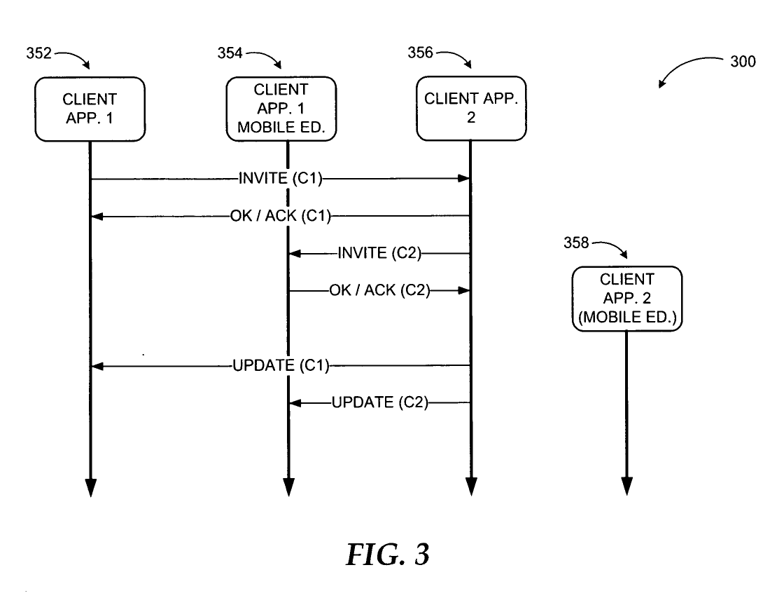

FIG. 3 is an action diagram illustrating interactions between different components of a communication system according to embodiments. As discussed above, a list of communication mode/endpoint identifiers are exchanged during the establishment of a conversation between client applications identifying communication mode capabilities of existing endpoints. In a SIP setting, the list may be a GRUU list exchanged in the initial INVITE and OK messages. The GRUU's for each modality may be indicated in the INVITE or OK messages by a predefined escalation header (e.g. “ms-escalate-to”), each message also including a conversation identifier (e.g. ms-conversation-id”).

According to an example scenario, a full version endpoint and communication phone version endpoint may be active at the same time. Upon accepting a call from a remote client application through the phone version, the outgoing OK message may have the GRUU of the full version endpoint in an instant message specific entry of the ms-escalate-to header. This is because the phone version endpoint may not be instant message capable.

On the other hand, if the conversation had started with an instant message on the full version endpoint, the outgoing OK message may have the GRUU of the phone version endpoint in the ms-escalate-to header specifying audio endpoint. This is because that the preferred audio device may be the communication phone version endpoint. While in the middle of a conversation, a client may send an UPDATE request with the new ms-escalate-to list upon changes to the endpoint(s)/software associated with the user. The remote party may then update its stored list with the new list.

Action diagram 300 illustrates another example scenario. According to the example scenario, full version communication application endpoint 352 is connected to the network (e.g. executed on a PC) with at least audio and text capabilities along with a mobile version of the communication application 354 with audio capabilities only. Second communication application with 356 may also include audio and text capabilities. Thus, an INVITE from client application 1 to the client application 2 for initiating an instant message conversation may include SIP identifiers of caller and called party, a call identifier (C1), content type (text), and preferred endpoints for available communication modes indicated by the predefined escalation headers. According to the example, full version communication application endpoint 352 may be identified as the preferred endpoint for text and phone version endpoint may be identified for audio. In one implementation the INVITE may look like:

INVITE
From: sip:bob@contoso.com
To: sip:carla@contoso.com
call-ID: C1
ms-escalate-to: sip:bob@contoso.com; endpoint=X; GRUU; text
ms-escalate-to: sip:bob@contoso.com; endpoint=Y; GRUU; audio
Content-Type: text,

where X and Y denote the full version and phone version endpoints respectively. The message may also include conversation id.

Client application 2 as endpoint 356 may respond with an OK message that reflects the endpoint's capabilities similarly:

OK/ACK
From: sip:carla@contoso.com
To: sip:bob@contoso.com
call-ID: C1
ms-escalate-to: sip:carla@contoso.com; endpoint=A; GRUU; text
ms-escalate-to: sip:carla@contoso.com; endpoint=A; GRUU; audio,

where A denotes the full version endpoint.

Later in the conversation, client application 2 may automatically add audio to the conversation based on a predefined policy or an intelligence module decision and do so by sending an INVITE with call identifier C2 to the phone version communication application (354) indicating content type audio. Client application 2 is enabled to submit this request directly to client application 1 mobile version endpoint designated as preferred endpoint for audio communication and preserve a nature of the conversation (e.g. rules, preferences) based on the initially exchanged list of GRUUs. Client application 1 mobile version may respond with an OK accepting the audio call with identifier C2.

According to another example scenario, also depicted on diagram 300, client application 2 mobile version (358) may be added in addition to the full version communication application. Now, full version client application 356 may be preferred for text communications and mobile version client application 358 for audio communications. This change in capabilities (and preferences) may be advertised through two UPDATE messages sent to corresponding active endpoints (client applications). The UPDATE messages may look like:

OK/ACK
From: sip:carla@contoso.com
To: sip:bob@contoso.com
call-ID: C1
ms-escalate-to: sip:carla@contoso.com; endpoint=A; GRUU; text
ms-escalate-to: sip:carla@contoso.com; endpoint=B; GRUU; audio,
and
OK/ACK
From: sip:carla@contoso.com
To: sip:bob@contoso.com
call-ID: C2
ms-escalate-to: sip:carla@contoso.com; endpoint=A; GRUU; text
ms-escalate-to: sip:carla@contoso.com; endpoint=B; GRUU; audio,

where A denotes the full version endpoint for client application 2 and B denotes the mobile version endpoint for client application 2. After this update, any escalations may also include client application 2 mobile version (358).

According to another example scenario in a system implementing embodiments, a first client application may be in a conversation with a second client application. The second client application may request the addition of instant messaging modality by sending an ms-escalate-to header for instant messaging. The first client application may then add a third client application to the call to make it a conference call. The call would be transferred to a conference server to facilitate the conference followed by the first client application adding instant messaging modality to accept the second client application's request. Finally, the second client application's instant messaging endpoint specified in the ms-escalate-to header may be looped in to complete the escalation.

While many communication modes and capabilities may be employed during an established conversation, example ones are described above for illustration purposes. The scenarios, example systems, conversation modes, and configurations discussed herein are for example purposes, and do not constitute limitations on embodiments. Other forms of communications, configurations, capabilities, and scenarios may be used in implementing multimodal escalation during a conversation in a similar manner using the principles described herein.

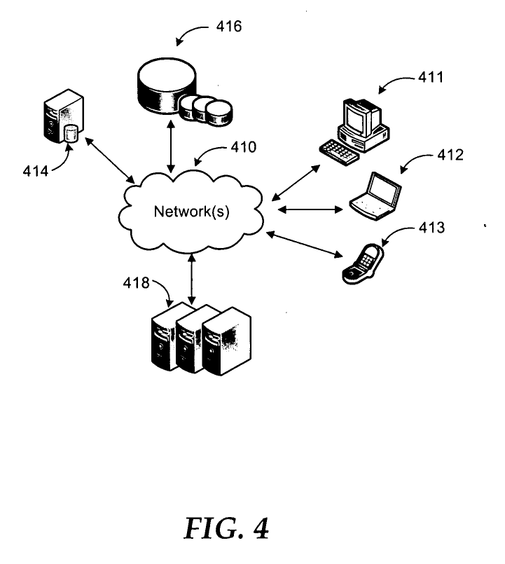

FIG. 4 is an example networked environment, where embodiments may be implemented. A platform providing multimodal communication services with escalation during a conversation may be implemented via software executed over one or more servers 418 such as a hosted service. The platform may communicate with client applications on individual computing devices such as a cellular phone 413, a laptop computer 412, and desktop computer 411 (client devices) through network(s) 410.

As discussed above, modern communication technologies such as UC services enable subscribers to utilize a wide range of computing device and application capabilities in conjunction with communication services. This means, a subscriber may use one or more devices (e.g. a regular phone, a smart phone, a computer, a smart automobile console, etc.) to facilitate communications. Depending on the capabilities of each device and applications available on each device, additional services and communication modes may be enabled.

Client devices 411-413 are used to facilitate communications through a variety of modes between subscribers of the communication system. One or more of the servers 418 may enable client applications to exchange complete lists of communication mode/endpoint identifiers such that escalation requests during a conversation are directed to the relevant endpoint preserving a nature of the conversation such as applied policy rules. Information associated with subscribers and facilitating communications with multimodal escalation may be stored in one or more data stores (e.g. data store 416), which may be managed by any one of the servers 418 or by database server 414.

Network(s) 410 may comprise any topology of servers, clients, Internet service providers, and communication media. A system according to embodiments may have a static or dynamic topology. Network(s) 410 may include a secure network such as an enterprise network, an unsecure network such as a wireless open network, or the Internet. Network(s) 410 may also coordinate communication over other networks such as PSTN or cellular networks. Furthermore, network(s) 410 may include short range wireless networks such as Bluetooth or similar ones. Network(s) 410 provides communication between the nodes described herein. By way of example, and not limitation, network(s) 410 may include wireless media such as acoustic, RF, infrared and other wireless media.

Many other configurations of computing devices, applications, data sources, and data distribution systems may be employed to implement a communication system with multimodal escalation. Furthermore, the networked environments discussed in FIG. 4 are for illustration purposes only. Embodiments are not limited to the example applications, modules, or processes.

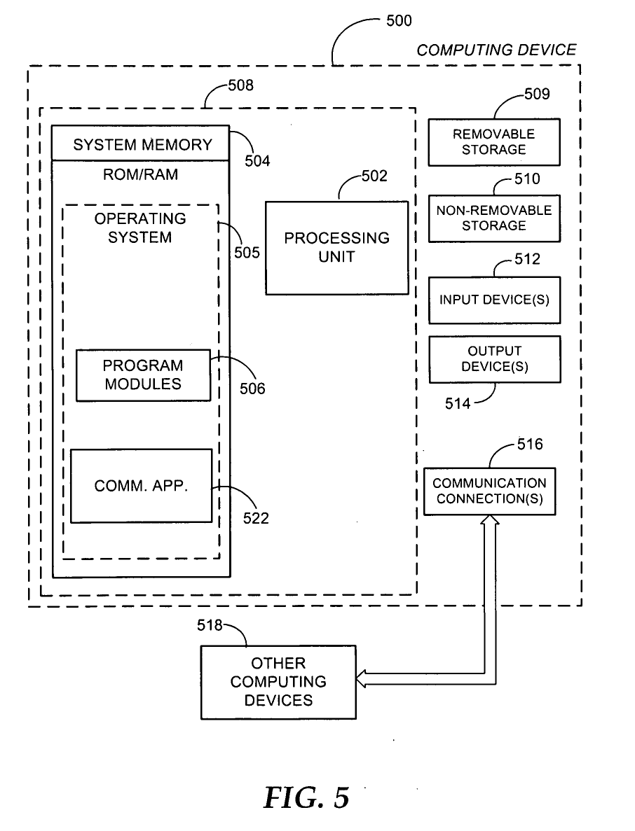

FIG. 5 and the associated discussion are intended to provide a brief, general description of a suitable computing environment in which embodiments may be implemented. With reference to FIG. 5, a block diagram of an example computing operating environment for an application according to embodiments is illustrated, such as computing device 500. In a basic configuration, computing device 500 may be a client device executing a communication application as part of an enhanced communication system and include at least one processing unit 502 and system memory 504. Computing device 500 may also include a plurality of processing units that cooperate in executing programs. Depending on the exact configuration and type of computing device, the system memory 504 may be volatile (such as RAM), non-volatile (such as ROM, flash memory, etc.) or some combination of the two. System memory 504 typically includes an operating system 505 suitable for controlling the operation of the platform, such as the WINDOWS® operating systems from MICROSOFT CORPORATION of Redmond, Wash. The system memory 504 may also include one or more software applications such as program modules 506 and communication application 522.

Communication application 522 may be part of a service that facilitates communication through various modalities between client applications, servers, and other devices. Communication application 522 may exchange a complete list of communication mode/endpoint identifiers during establishment of a conversation automatically and update on an as needed basis as discussed previously. This basic configuration is illustrated in FIG. 5 by those components within dashed line 508.

Computing device 500 may have additional features or functionality. For example, the computing device 500 may also include additional data storage devices (removable and/or non-removable) such as, for example, magnetic disks, optical disks, or tape. Such additional storage is illustrated in FIG. 5 by removable storage 509 and non-removable storage 510. Computer readable storage media may include volatile and nonvolatile, removable and non-removable media implemented in any method or technology for storage of information, such as computer readable instructions, data structures, program modules, or other data. System memory 504, removable storage 509 and non-removable storage 510 are all examples of computer readable storage media. Computer readable storage media includes, but is not limited to, RAM, ROM, EEPROM, flash memory or other memory technology, CD-ROM, digital versatile disks (DVD) or other optical storage, magnetic tape, magnetic disk storage or other magnetic storage devices, or any other medium which can be used to store the desired information and which can be accessed by computing device 500. Any such computer readable storage media may be part of computing device 500. Computing device 500 may also have input device(s) 512 such as keyboard, mouse, pen, voice input device, touch input device, and comparable input devices. Output device(s) 514 such as a display, speakers, printer, and other types of output devices may also be included. These devices are well known in the art and need not be discussed at length here.

Computing device 500 may also contain communication connections 516 that allow the device to communicate with other devices 518, such as over a wired or wireless network in a distributed computing environment, a satellite link, a cellular link, a short range network, and comparable mechanisms. Other devices 518 may include computer device(s) that execute communication applications, other directory or policy servers, and comparable devices. Communication connection(s) 516 is one example of communication media. Communication media can include therein computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Example embodiments also include methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be collocated with each other, but each can be only with a machine that performs a portion of the program.

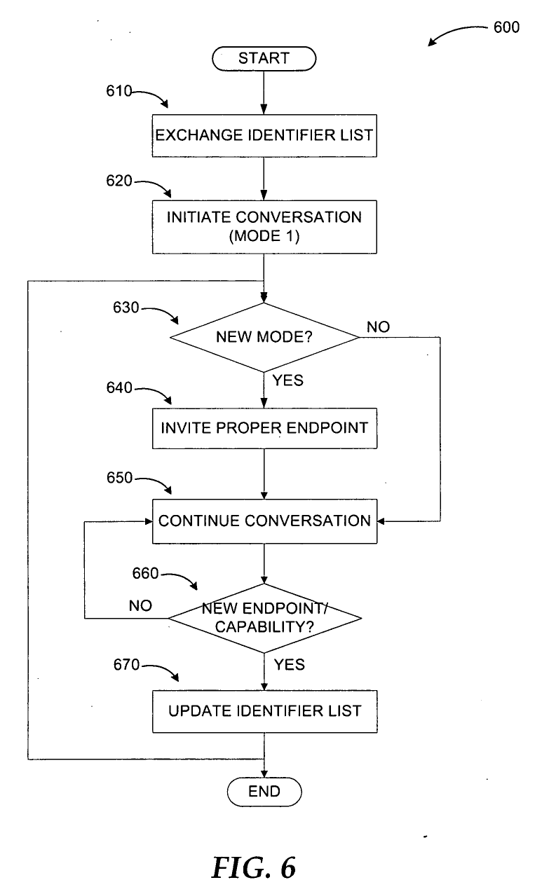

FIG. 6 illustrates a logic flow diagram for process 600 of managing multimodal escalations during a conversation in a communication system according to embodiments. Process 600 may be implemented as part of a communication system that facilitates multiple communication modes.

Process 600 begins with operation 610, where a communication mode/endpoint identifier list (e.g. a GRUU list) is exchanged between two or more client applications (and/or bots) attempting to initiate a conversation. The exchange may be accomplished through the INVITE and OK messages. At operation 620, the conversation is initiated employing the desired mode (mode 1). A determination is made at decision operation 630 whether a new communication mode is desired or needed. If a new communication mode is desired or needed and the exchanged list includes endpoints capable of facilitating the desired communication mode, that endpoint(s) is invited at operation 640. If no new communication mode is desired, the conversation continues in communication mode 1 at operation 650.

Another determination is made at decision operation 660 as to whether a new endpoint or a new communication mode capability is added. For example, one of the users may log in to an additional endpoint with an additional communication mode capability (e.g. a video communication or instant message capable device). Alternatively, an existing endpoint may increase its capability through connection of a new peripheral device or software modification (e.g. change of capabilities based on location of user, network connection, time of day, available bandwidth, etc.). If the new endpoint or capability is added, the original identifier list may be updated by the new/modified endpoint and advertised to the other endpoints at operation 670. If no change occurs, the conversation continues as before. After the identifier list is updated, processing may return to decision operation 630 to determine if a new communication mode is desired based on the additional endpoint/capability.

The operations included in process 600 are for illustration purposes. A communication service with multimodal escalation capability may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method to be executed at least in part in a computing device for multimodal escalation in enhanced communication systems, the method comprising:
enabling exchange of information on available endpoints and associated communication modes prior to establishing a conversation employing a first communication mode;
establishing the conversation employing the first communication mode;
enabling an escalation to a second communication mode by transmission of a request directly to an endpoint associated with the second communication mode as indicated by the exchange of information; and
continuing the conversation employing the second communication mode upon acceptance of the escalation by the endpoint associated with the second communication mode.

2. The method of claim 1, further comprising:
enabling a modification of the exchanged information on available endpoints and associated communication modes during the conversation by transmitting an update message with information on one of newly added and newly removed endpoints and communication mode capabilities.

3. The method of claim 1, wherein the conversation is between an automated communication application and at least one endpoint, and one of the automated communication application and the at least one endpoint are enabled to escalate to the second communication mode employing an escalation header in an invitation message.

4. The method of claim 3, wherein one of the automated communication application and the at least one endpoint are enabled to switch their respective communication modes based on one of a presence and an absence of the escalation header in the invitation message.

5. The method of claim 1, wherein a change in available endpoints and communication modes is caused by one from a set of: one of the communicating users adding a new endpoint, one of the communicating users deactivating an existing endpoint, one of the communicating users adding a peripheral, one of the communicating users removing an existing peripheral, a programming change, a network condition change, and a permission status change.

6. The method of claim 1, wherein enabling exchange of information on available endpoints and associated communication modes prior to establishing the conversation includes:
enabling a user requesting the conversation to list their available endpoints and associated communication modes in an invitation message to called users; and
enabling called users to list their available endpoints and associated communication modes in an acknowledgment message.

7. The method of claim 6, wherein the invitation and the acknowledgment messages include a listing of each available endpoint associated with a user preceded by a predefined escalation header and a preferred communication mode for each available endpoint.

8. The method of claim 6, wherein any communication mode escalation requests are transmitted only to an endpoint associated with the communication mode to which the escalation is requested.

9. The method of claim 1, wherein the first and the second communication modes include at least one from a set of: a voice communication, a video communication, a white-boarding session, a data sharing session, an application sharing session, an instant messaging session, and an email exchange.

10. The method of claim 1, wherein an attribute of the conversation that is set when the conversation is initially established is maintained automatically after the escalation to the second communication mode.

11. The method of claim 1, wherein the escalation is implemented following confirmation of participating endpoints' capabilities, if the conversation is a conference conversation involving a plurality of client applications.

12. The method of claim 1, wherein the first and the second communication modes are facilitated simultaneously following the escalation.

13. A communication system for implementing unified communications with multimodal escalation, the system comprising:
a communication server configured to facilitate multi-modal communications between end-points of the system employing Session Initiation Protocol (SIP);
a first client application managing at least one endpoint, the first client application configured to:
transmit an INVITE message to initiate a conversation employing a first communication mode, wherein the INVITE message includes a list of available endpoints and associated communication modes;
upon receiving an OK message in response to the INVITE message facilitate the conversation employing the first communication mode;
if one of the available endpoints and communication capabilities associated with the endpoints changes during the conversation, transmit an UPDATE message for updating the list of available endpoints and associated communication modes; and
a second client application managing at least one endpoint, the second client application configured to:
transmit an OK message in response to the INVITE message to initiate the conversation, wherein the OK message includes a list of available endpoints and associated communication modes for the second client application; and
if one of the available endpoints and communication capabilities associated with the second client application changes during the conversation, transmit an UPDATE message for updating the list of available endpoints and associated communication modes for the second client application.

14. The system of claim 13, wherein the available endpoints are identified by corresponding Globally Routable User Agent Uniform Resource Identifiers (GRUUs).

15. The system of claim 13, wherein the second client application is further configured to:
escalate to a second communication mode by transmitting another INVITE message directly to an endpoint associated with the second communication mode as indicated by the list of available endpoints and associated communication modes; and
continue the conversation employing the second communication mode upon acceptance of the escalation by the first client application.

16. The system of claim 13, wherein the first client application and the second client application are executed on one from a set of: a smart phone, a cellular phone, a laptop computer, a desktop computer, and a smart automobile console.

17. A computer-readable storage medium with instructions stored thereon for managing multi-modal communications with enhanced escalation during a conversation, the instructions comprising:
exchanging a first list and a second list of available endpoints and associated communication modes for a first user and a second user, respectively, through an invitation message and an acknowledgment message prior to establishing a conversation employing a first communication mode;
establishing the conversation between the first and the second user employing respective preferred endpoints for the first communication mode;
in response to an indication by one of the first and second users, escalating to a second communication mode by transmitting a new invitation message from the indicating one of the first and second users directly to an endpoint associated with the second communication mode as indicated in one of the first and second lists;
continuing the conversation employing the second communication mode upon acceptance of the escalation by the endpoint associated with the second communication mode; and
in response to a change in available endpoints and communication modes associated with one of the first and second users, transmitting an update message with a modified list of available endpoints and associated communication modes to the remaining endpoints during the conversation.

18. The computer-readable medium of claim 17, wherein the invitation message and the acknowledgment message include identifiers for the first and second users, an identification of a current communication mode, a type of the current communication mode, a conversation identifier, and a list of the available endpoints and a preferred communication mode for each endpoint.

19. The computer-readable medium of claim 17, wherein the change in available endpoints and communication modes includes at least one from a set of: a capability of participating client devices, joining of the conversation by an additional user, a change in user rights, and a change in network based conditions.

20. The computer-readable medium of claim 19, wherein the update message is further transmitted in response to one of: an active endpoint becoming inactive and an endpoint with higher preference by one of the first and second users becoming active.
